(19) United States
(12) Patent Application Publication
(10) Pub. No.: US 2024/0420298 A1
(43) Pub. Date: Dec. 19, 2024

(54) METHOD OF MONITORING IMAGES

(71) Applicant: PETRÓLEO BRASILEIRO S.A. - PETROBRAS, Rio de Janeiro (BR)

(72) Inventors: Ricardo Soares MINETTE, Rio de Janeiro (BR); Paulo Romero Zanconato PINTO, Rio de Janeiro (BR); Andre COSTA, Santos (BR); Luis Arthur Ferreira PINTO, Rio de Janeiro (BR); Ivan Koji KOGA, Rio de Janeiro (BR); Fernanda Gomes PINHEIRO, Rio de Janeiro (BR); Thyago Silva HERMETO, Rio de Janeiro (BR)

(21) Appl. No.: 18/640,649

(22) Filed: Apr. 19, 2024

(30) Foreign Application Priority Data
Jun. 19, 2023 (BR) 1020230121403

(51) Int. Cl. G06T 7/00; G06V 10/74; G08B 21/00

(52) U.S. Cl. CPC G06T 7/0002; G06V 10/761; G08B 21/00; G06T 2207/30168

(57) ABSTRACT

The present invention discloses a method of monitoring images, particularly images from cameras on offshore platforms, where only low-frequency events trigger alarms and high-frequency events are ignored. Preferably, it implements the Multi-scale Structural Quality Score where the compared image frames are spaced in time, for example, by a space of 1 minute, 10 minutes, 15 minutes, 30 minutes, or 60 minutes. If a quality score lower than a threshold quality score is obtained, or if the quality score obtained remains within a predetermined range for a time greater than a predetermined time limit, an alarm may be triggered. Accordingly, only events that represent a significant risk to operational and personnel safety and that persist for a certain period will trigger alarms. Consequently, spurious alarms that would be caused by low relevance events are avoided.

### FIELD OF THE INVENTION

The present invention falls within the field of image monitoring. More specifically, the present invention relates to methods for monitoring images captured by video cameras in aircraft landing and takeoff areas.

### BACKGROUND OF THE INVENTION

Landing and takeoff are among the most critical steps in air transportation due to the low speed and height, the short reaction and decision times available to the pilot and the weather conditions. These difficulties are even more severe in the offshore environment due to the relative movements of helipads and the restricted space for maneuvers.

According to Brazilian Navy and Brazilian Air Force regulations, helidecks must be equipped with cameras to monitor approach, landing and takeoff operations.

To ensure the functioning of oil and gas (O&G) exploration and production activities, the logistics segment plays an important role in the process, considering that all inputs for the maintenance of the operational plant and its employees need to be transported, whether by air or by sea. Furthermore, one must consider the daily challenge of providing just-in-time logistics in a hostile environment, according to the IOGP (International Association of Oil & Gas Producers), at long distances from the coast and local metoceanographic conditions. This complex operation brings with it even greater challenges that are not limited to the technological sphere, but that bring critical security aspects.

According to the Brazilian Navy (DPC—Directorate of Ports and Coasts) and the Brazilian Air Force (ICA—Institute of Aeronautical Cartography), helidecks must be equipped with cameras to monitor the approach, landing and takeoff phases. These standards are ICA 63-25 and NORMAM 27, the latter being clear regarding the operation and positioning criteria of the cameras, in addition to recording the most critical stage of the aeronautical operation, which is the landing and take-off in sea units, as exemplified by the P-77 platform illustrated in FIG. 1. Therefore, the filming system must be parameterized to present the frame 3 times the largest dimension of the project aircraft (D) as demonstrated in FIG. 2.

However, aeronautical security cameras can be used for other activities to support security management, resulting in a momentary loss of the framework provided for in the regulation or, in some instances, maintenance degradation of the system components. The potential for improvement in the process gap, identified as human error, was verified.

Conventionally, automatic image monitoring can be made using algorithms that compare a current image frame with a previous frame. If a significant difference is identified in this comparison, an alarm can be triggered to an operator to warn of a possible failure or attempted sabotage. There are many techniques known in the literature that can achieve these goals, such as pixel difference, for example.

Conventional automatic image monitoring systems, such as anti-sabotage systems, are alarmed whenever a comparison between frames produces a significant difference between them. If such conventional systems were applied to platform helideck cameras, the systems would be alarmed most of the time due to the large number of events that occur throughout the day. Such events in this environment, designated as high-frequency events for being very common and of short duration, include, for example: birds flying around the helideck, birds landing close to and blocking the view of the camera, water on the camera lens or dome, the approach of vessels, landing and take-off of an aircraft, incidence of sunlight, clouds blocking the sun, shadows from elevated structures, and so on. Such a situation is undesirable since these events are routine events and do not represent a risk situation for the aircraft or platforms.

At the same time, low-frequency events may pose operational risks or impossibility of operation. For example, low-frequency events may include an aircraft stopped for a prolonged period on the helideck (for example, for more than 4 hours), storms sustained for prolonged periods, some type of obstruction in the camera's view or dirt that prevents perfect viewing from the helideck for prolonged periods of time.

Therefore, the art lacks monitoring systems that are not alarmed in the presence of high-frequency events while being alarmed in the presence of low-frequency events.

### STATE OF THE ART

International publication WO 2017/085708, published on May 26, 2017, entitled “Method of controlling a quality measure and system thereof”, refers to a computerized method and system of controlling a quality measure in a compression quality evaluation system, the method comprising: calculating a grain value indicative of an extent of grain present in an input image, the grain value being calculated based on one or more features characterizing a base image related to the input image; and configuring the quality measure upon a criterion being met by the value, the quality measure being indicative of perceptual quality of a compressed image compressed from the input image.

The calculated grain value may be dependent also on further characteristics of the input image, or in the case of a sequence of images, dependent also on the relation between the image and the preceding image. The technology disclosed in WO 2017/085708 provides for the comparison of image frames to verify image quality using the MS-SSIM technique.

Although the prior art provides various details and embodiments about the MS-SSIM technique, there are no teachings or suggestions of features that would allow a monitoring system to trigger an alarm when detecting low-frequency events while not triggering an alarm when detecting high frequency events.

### SUMMARY OF THE INVENTION

The present invention implements a Relative Quality Score (RQS), where image frames spaced in time (instead of being sequential frames) are obtained and compared with a reference image frame to obtain a Quality Score (QS), then the median of the obtained QSs is calculated to achieve the RQS. For example, image frames can be spaced 1 minute, 10 minutes, 15 minutes, 30 minutes, or 60 minutes apart, without limitation. For example, the QS can be taken as a measure of the Multi-scale Structural Similarity Index Measure (MS-SIM) or by the ratio of the Laplacian variances. Moreover, a similarity index tolerance and/or a tolerance for how long frames can remain below a threshold relative quality score is optionally implemented to detect whether there is a significant difference between the frames being compared to the reference image. Accordingly, high-frequency events, such as a brief rain or the passing of a bird through the frame, do not cause the monitoring system to become alarmed.

At the same time, the monitoring system can be configured in such a way that, for example, an object blocking the image, which could be a bird sitting in front of the camera, does not generate an alarm as long as it remains for less than a time limit period, that is, the system detects that the quality score between the two frames being compared remains lower than a threshold quality score (because of the presence of the bird) for a certain time limit period, for example, 10 minutes. In this example, if the bird remains blocking the camera for longer than the exemplary time limit of 10 minutes, an alarm will be triggered so that the error can be corrected.

Optionally, the system can generate a periodic report containing one or more of the frames compared over the considered period and their QSs for subsequent analysis.

### BRIEF DESCRIPTION OF THE DRAWINGS

The present invention will now be described with reference to typical embodiments thereof and also with reference to the attached drawings, in which:

FIG. 1—Shows a photograph of a sea unit (P-77) where the present invention can be applied;

FIG. 2—Represents the framing requirements of the filming system that monitors a helideck;

FIG. 3 is a representation of an exemplary computer network for carrying out the method according to the present invention;

FIG. 4 is a representation of the present invention;

FIG. 4 is a representation of an alternative exemplary computer network for carrying out the method according to the present invention;

FIGS. 5A, 6A and 7A are representations of out-of-frame images while FIGS. 5B, 6B and 7B are representations of their respective reference images;

FIGS. 8A, 9A and 10A are representations of low sharpness images while FIGS. 8B, 9B and 10B are representations of their respective reference images;

FIG. 11 is a representation of an exemplary flowchart of an embodiment of the method according to the present invention.

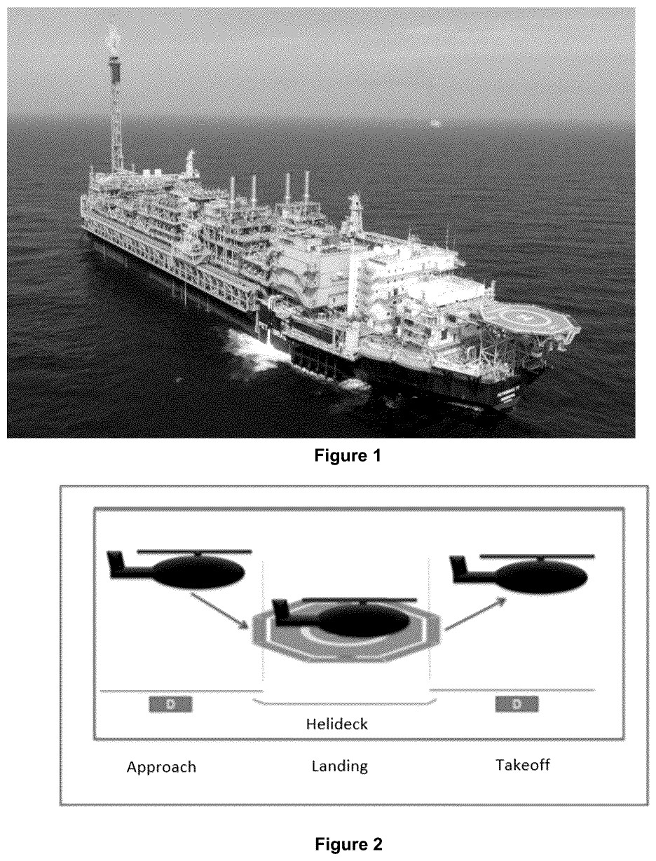

### DETAILED DESCRIPTION OF THE INVENTION

Specific embodiments of this disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system- and business-related constraints, which may vary from one implementation to another. Furthermore, it should be appreciated that such a development effort may be complex and time-consuming, but would nevertheless be a routine design and manufacturing undertaking for those of ordinary skill having the benefit of this disclosure.

The present invention discloses a method of determining a Relative Quality Score, obtained by calculating the median of several Quality Scores obtained during a period of observation in which time-spaced image frames are taken at predetermined intervals and are each compared to a reference image frame. Such a comparison between the obtained image frame and the reference image frame provides a Quality Score (QS) that ranges from 0 to 1, where an QS equal to 1 indicates that the compared frames are identical and an QS of less than 1 indicates that there is some difference between the compared frames. Such differences can be due to a large number of factors, including, but not limited to, framing, brightness, sharpness, and focus.

At the end of a monitoring period where image frames are obtained, the median of all of the obtained QSs is calculated, resulting in a Relative Quality Score (RQS), which also ranges from 0 to 1. An RQS close to 1 indicates that the majority of QSs obtained during the monitoring period were close to 1, which means that during most of the monitoring period the obtained image frame was similar to the reference image frame. In practice, this means that there were relatively few variations in the obtained images.

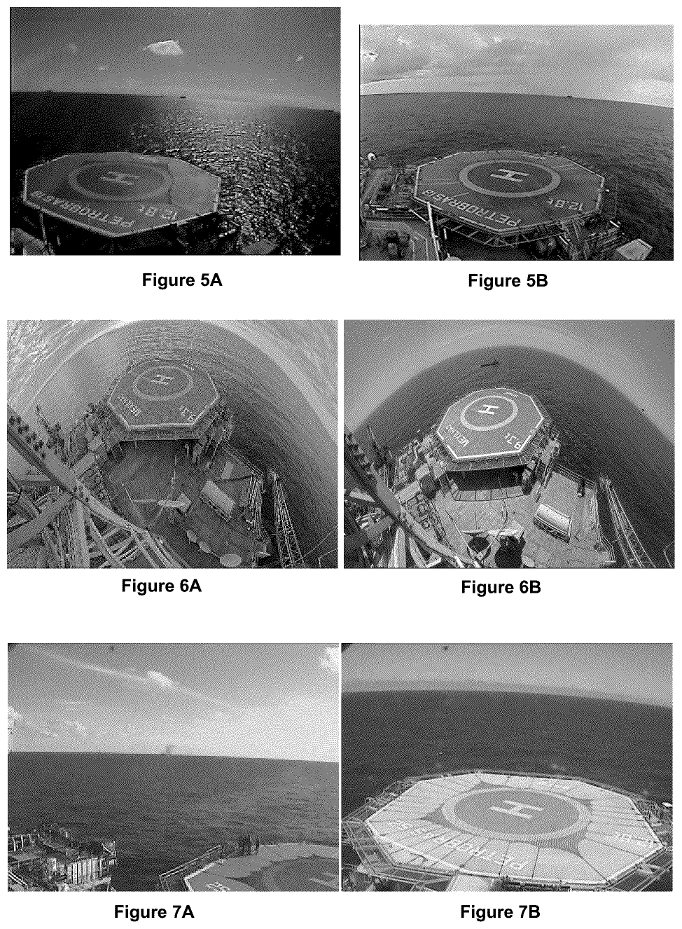

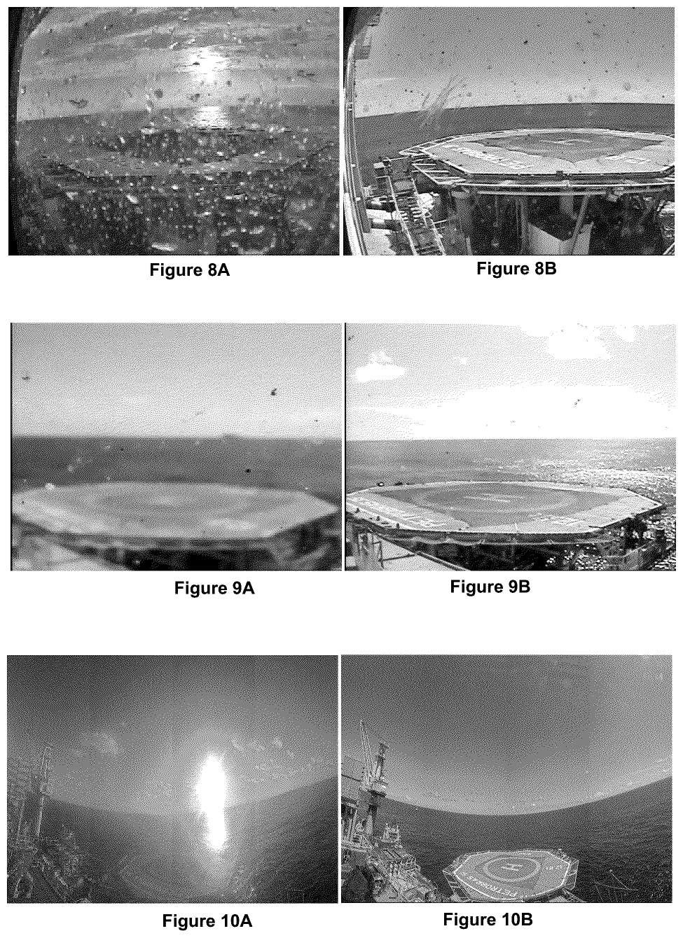

As an example, attention is drawn to FIGS. 5A-10B. FIGS. 5A, 6A and 7A illustrate images with a framing error, while FIGS. 5B, 6B and 7B illustrate images where the image lacks sharpness. FIGS. 5B, 6B, 7B, 8B, 9B, and 10B illustrate the respective reference images of FIGS. 5A, 6A, 7A, 8A, 9A, and 10A with good framing and good sharpness.

Different comparison methodologies can be used to obtain an QS between two image frames. Optionally, multiple methodologies can be applied simultaneously, which can result in multiple QSs and multiple RQSs. Without limitation, some of these methodologies are mentioned below:

Structural Similarity Index Measure-SSIM can be used to compare two images and calculate the similarity value between them. Particularly suitable for identifying differences in framing.

Laplacian Filter: can be applied to an image to enhance edges and detect image sharpness. Therefore, by calculating the variance of the result of this filter, it is possible to check the degree of sharpness of an image in relation to another reference image, through a ratio of suhc sharpness degrees.

Sobel filter: used to detect edges in images. Its result can be used to check image quality and to calculate the difference between two images.

Mean Squared Error—MSE: is a mathematical formula that calculates the mean squared error between two images, making it possible to use this formula to measure image quality and the difference between two images.

Peak signal-to-noise ratio—PSNR: is a metric that measures the ratio of signal to noise present in an image, allowing one to assess the quality of the image and the noise level present.

The present invention preferably, but without limitation, uses a version of the SSIM designated Multi-scale Structural Similarity Index Measure—MS-SIM) in combination with the Laplacian variance ratio. However, any image frame comparison methodology, or combination thereof, can be used without departing from the scope described herein. Structural similarity index measurement (SSIM) is a method used to measure the similarity between two images. This technique predicts the perceived quality between two images, and was initially developed for applications in digital television and cinematic images, as well as other types of digital images and videos. A more advanced form of the SSIM is the Multi-scale Structural Similarity Index Measure—MS-SIM), which is carried out at multiple scales through a multi-stage subsampling process. Such an improved technique performs as well as or outperforms the SSIM on different subjective image and video databases.

According to Nasr, M. A. S; AlRahmawy, M. F. and Tolba, A. S. (2016), the differences between SSIM (SSI) and MS-SSIM are:

“The SSI measurement system (Wang and Bovik, 2002) is based on modeling luminance, contrast and image structure. MS-SSIM is an extension of the SSI system that achieves better precision than the single-scale SSI approach, but at the cost of relatively lower processing speed. However, the calculations required for MSSSIM do not require as much computational time as required by other efficient statistical learning algorithms (Avcιbas et al., 2002), as they require complex calculations. Our system applies MS-SSIM for motion detection in videos; whether online videos captured directly from the camera or recorded videos stored in a file. Any video is sequenced into frames and successive frames are compared to each other and if a difference is detected, an alarm is triggered. The proposed approach relies on a new algorithm that aids in the local adaptation of the multi-scale structural similarity measurement for motion detection in videos. In the next sections we present the basic SSI measurement system as it is the basis of the algorithm used, the MSSSIM; below we present the MSSSIM itself. Next, we present our proposed algorithm for motion detection using MS-SSIM”. (2016)

The SSIM and MS-SSIM techniques are already well known in the art, so their details will not be discussed herein.

The similarity technique described by Nasr and AlRahmawy is used in Closed Circuit Television (CCTV) systems, but such use is not seen in offshore helidecks. The inventors realized that they could use a technique adapted from MS-SSIM to identify movements detected by security cameras that already exist on offshore platforms in compliance with ICA 63-25 and NORMAM 27 standards. The MS-SSIM technique has greater accuracy and processing speed, and high reliability as it is based on luminance, contrast and structural changes, making it very suitable for motion detection applications.

Intelligent Video Analytics—IVA is a technology that allows one to continuously identify events and objects in scenes in images captured by security cameras. Despite being a technology of more than 20 years of development, it has been gaining strength with the increased computational power in recent years and the development of artificial intelligence systems, such as deep neural networks. This technology has enormous potential for use in operational security, helping to assess risks, deviations and incidents without the need for additional sensors.

Implementation on PETROBRAS platforms—with the generation of automatic reports for later analysis, presented satisfactory results in managing the aeronautical safety process during routine operations and investigations of anomalous aeronautical events. Thirty-eight PETROBRAS sea units were found to have the same software management system which was already fully integrated into the company's data network.

The method of the present invention is preferably based on the MS-SSIM technique applied to image frames obtained by one or more cameras on the platform and stored in a database. Irregularities in the images (framing failure, dirt, wet camera lens, etc.) cause the detected similarity index to change. For example, by comparing a first frame with a second frame, a similarity index of 1 indicates that they are both identical frames. A similarity index of less than 1 indicates that the second frame has differences in relation to the first frame.

Conventional monitoring methods, such as those used in anti-tampering systems, compare each of the frames captured by the camera with their respective immediately preceding frames. By detecting that the similarity index has dropped below 1, an alarm is triggered.

As previously mentioned, this is undesirable in the environment of offshore platforms as there is a large number of high-frequency events throughout the monitoring period. Implementation of such conventional monitoring methods on offshore platforms would result in constant alarms being triggered caused by events of little or no relevance to the safety of aircraft and personnel. For example, brief rains, birds, sunlight on the camera, aircraft landing and takeoff.

Furthermore, comparison of each of the frames captured by the camera requires relatively high processing capacity and energy consumption, which is also undesirable.

According to the present invention, for a current analysis of the images used in Python with the OPENCV and SKIMAGE libraries, for a quality compatible with the case of identification of movement or change in the positioning of cameras and also for comparing images, without the current image being made with a reference from the same camera. For framing analysis, SKIMAGE preferably uses the structural similarity of the current image with the reference image, establishing a library evaluation threshold.

As previously mentioned, MS-SIM is particularly suitable for detecting differences in framing between two images. This difference can be caused by remote motion of the camera by an operator, sabotage, accidental impact, among others. In addition to correct framing to meet safety standards, it is also necessary for the image quality to remain high enough to be readable. For quality analysis, the Laplacian variance ratio is preferably used, as shown in Equation 1 below. Thus, it is possible to establish an acceptable limit for the loss of image quality.

cv2.Laplacian (ImageNow). var( )/cv2.Laplacian(ImageRef). var( ) (1)

The above relationship results in a number that can range from 0 to 1. For “1”, the assessed image has the same sharpness as the reference image and for values other than 1 there are differences between the assessed image and the reference image.

Obviously, the choice of the Python language and its libraries are just examples. The person skilled in the art may use other ways to carry out the method described herein in the computational environment without departing from the scope of the invention. A consequence of the monitoring method according to the present invention was the availability of the aircraft arrival and departure times within the scope of the unit. Aircraft arrival and departure causes disturbances in the QS that can be indicated in a report generated at the end of the monitoring period. This information makes it possible to optimize aviation safety processes, more specifically with regard to the assessment of landings with possible incidents or that require future investigations.

The method proposed herein for comparing static images is close to a background subtraction technique. However, a median RQS of the QSs obtained throughout the monitoring time is calculated. In practice, helidecks are only in use during part of the day, for example between 7 am and 6 pm. At other times, no monitoring is carried out as the helideck is not in use. Furthermore, the absence of natural light and/or the use of artificial light would distort the result of the quality comparison.

Therefore, the median RQS is based on a period greater than 5 hours. Medians eliminate effects that can cause false detections due to shadows, lighting variations, and other high-frequency motion changes.

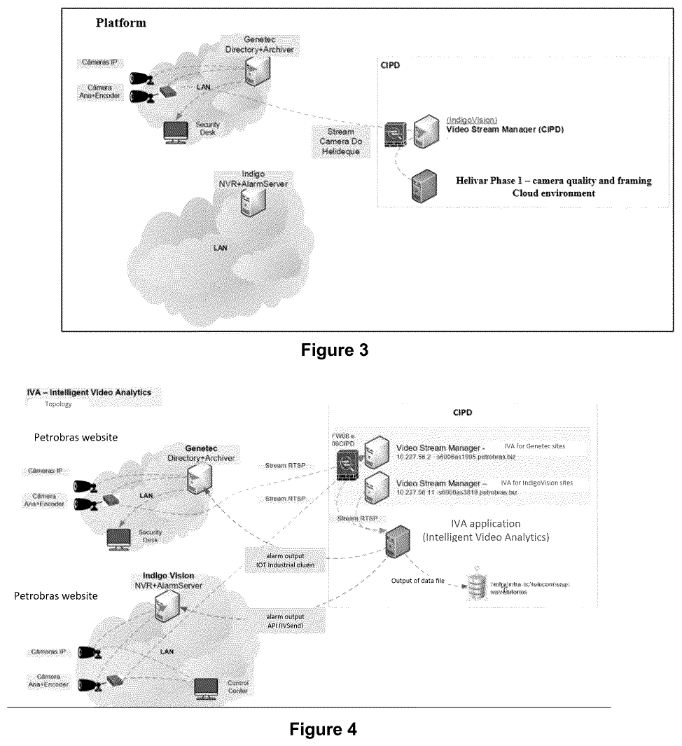

The method of the present invention can be carried out by any computer equipped with software capable of carrying out processing required by the chosen image comparison methodology, preferably MS-SSIM, and IVA and which is connected to an infrastructure suitable for this purpose. Without any limitation, exemplary systems are shown in FIG. 3. Advantageously, systems like these are already in operation on all offshore platforms in compliance with the current regulations. For example, the network in FIG. 3 comprises one or more monitoring cameras installed on the offshore platform, each camera being connected via wired or wireless means (for example, via LAN) to a local computer configured to manage the camera operation, including receiving and storing data from each camera, and to carry out the comparison methodology, as will be described below. Optionally, the local computer can be configured to display the data and QSs obtained in real time on a display screen. Optionally, the platform's set of cameras and local computer can send the obtained data to a second computer or a cloud, where the data will be stored and can be processed and/or treated according to specific needs. Optionally, the comparison methodology can be carried out on the second computer or cloud instead of being carried out on the local computer, with the local computer only having the task of managing the camera operation. Optionally, the local computer can send the images obtained by the cameras in real time to the second computer or cloud. Optionally, as seen in FIG. 4, the second computer or cloud can be connected to more than one local computer on a platform, being able to receive real time data and/or images and/or carry out the comparison methodology for each platform in a centralized configuration of multiple offshore monitoring systems.

The systems and devices required to create the networks exemplified in FIGS. 3 and 4 are widely known in the art, so they will not be discussed in greater detail here. The person skilled in the art will be able to choose network topologies, system and equipment according to the specific needs without departing from the scope of the present invention.

The present invention advantageously compares frames spaced by a certain timeframe, for example, 1 minute, 10 minutes, 15 minutes, 30 minutes, or 60 minutes, without being limited to these, instead of being sequential frames. Thus, the processing capacity and energy consumption are reduced.

Briefly, a comparison is made between a predetermined reference frame and a first image frame obtained during a monitoring period, and the quality score of the first image frame obtained relative to the reference image frame is obtained. If the quality score is different from 1, that is, the first image frame obtained during the monitoring period is different from the reference image frame, an event took place at the time of obtaining the first obtained image frame. In some applications, an alarm can be triggered immediately if this QS is below a predetermined threshold, as will be seen later.

After a predetermined period of time, for example, 1 minute, a new image frame is obtained. This second obtained image frame is compared to the reference image frame and a new second QS is obtained. This process is repeated until the monitoring period ends, for example, after five hours have passed since the start of the monitoring period.

In a preferred embodiment, the method of the present invention chooses a reference frame Qr, for example, a frame taken by the camera at a predetermined time where the helideck conditions are optimal. Such a moment could be, for example, one in which the camera's view is completely unobstructed, the lighting is optimal, the wind speed and direction are within a safe range, or any other criteria you wish to adopt. Alternatively, the reference frame Qr can be taken by the camera at the beginning of the monitoring period and taken again at the beginning of the next monitoring period. Alternatively, it is possible to adopt a standard reference frame Qrp taken by the camera at a predetermined time when the helideck conditions are optimal and a variable reference frame Qrv taken by the camera at the beginning of the monitoring period, being taken again at the beginning of the next monitoring period.

During the monitoring period, an additional frame Qn is taken by the camera preferably at the start of the monitoring period or, optionally, after a predetermined time t has passed from the start of the monitoring period, e.g. 1 minute, 10 minutes, 15 minutes, 30 minutes, or 60 minutes, but not limited to these, if the reference frame is obtained at the beginning of the monitoring period. The quality score between the additional frame Qn and the reference frame Qr is determined and stored in a memory. Successive additional frames Qn are taken during the monitoring period and their respective quality indices relative to the reference frame Qr are determined and stored in the memory.

Preferably, each additional frame Qn is spaced from the previous one by the time t, although the present invention is not limited thereto. If desired, it is possible to vary the time t between taking each additional frame Qn during the monitoring period. For example, the time t may be set to 10 minutes during a first part of the monitoring period, may be set to 1 minute during a second part of the monitoring period, and may be set again to 10 minutes during a third and final part of the monitoring period. In this example, the second part of the monitoring period may be a time when there is greater activity and a more accurate and higher resolution monitoring is desired.

At the end of the monitoring period, a median (QSm) of the quality indices obtained is calculated and a report can be generated for later review. The value calculated for the median QSm can indicate whether there was a significant number of low-frequency events that could harm the safety of personnel and equipment.

In one example, a median between 0.8 and 0.9 may indicate that the events of this particular monitoring period caused interference as expected. For example, landings and takeoffs occurred in a timely manner, lighting was adequate most of the time, and there was no camera obstruction. Even though certain events reduced some of the obtained quality scores, for example, by a cloud obscuring the sun or a bird obscuring the camera's view, such events were sufficiently brief, i.e., high in frequency, so that the median of all quality indices obtained during the particular monitoring period remained high.

In one example, a median below 0.8 may indicate that an event has extended long enough to affect the safety of the operation and personnel. In other words, it may indicate the occurrence of a low-frequency event. This may lead to a review of the Qn frames obtained during the monitoring period or even the entire recording obtained by the camera to identify the aforementioned low-frequency event and take the necessary actions.

In one example, a median below 0.6 may indicate a serious low-frequency event that requires urgent correction. In one example, a median below 0.5 may indicate a very serious low-frequency event that requires immediate correction.

In one example, a median greater than 0.9 may indicate an atypical monitoring period, where there were very few events, possibly also giving rise to further review and investigation.

In an example where a standard reference frame Qrp and a variable reference frame Qrv as previously defined are adopted, two quality index medians can be determined, where a first median QRmp uses the Qrp as a reference and a second median QRmv uses the QRV as a reference. These medians can indicate the occurrence of events in relation to an optimal reference, Qrp, which can indicate the occurrence of any events; and relative to a variable reference frame, Qrv, which can indicate a staggered influence of the events. For example, if the Qrp is taken at a cloudless and unobstructed moment, a prolonged storm tends to reduce the median of the monitoring period. If the Qrv is taken during a storm, slight worsening or improvement in the weather would not significantly influence the median, while the passage of the storm would have a very relevant influence.

Optionally, an alarm or alert may be triggered if a relative quality score obtained in accordance with any of the embodiments disclosed above is below a threshold quality score. Some low frequency events may be such that immediate action is required. Otherwise, certain operations may be highly sensitive and may require more rigorous monitoring. For example, the alarm may be triggered if a relative quality score is less than a threshold quality score of 0.9, or 0.8, or 0.7, or 0.6, or 0.5, without being limited thereto. This alarm can be saved in the memory and later included in the report for further analysis.

Advantageously, restricting alarm triggering to relative quality scores that are below a threshold quality score prevents variations caused by events of low or no relevance to operational and personnel safety from triggering an alarm, for example, a bird that has landed within the framing of the camera.

In one example of application, the monitoring system using the method described herein can be configured with a Qrp taken under optimal conditions and with a threshold quality score of 0.7. A landing and takeoff event for an aircraft such as a helicopter, in this example, can take around 10 minutes for just boarding and/or disembarking of personnel or up to 60 minutes for loading and/or unloading cargo. Such an event can take the quality score to values close to 0.8, meaning that an alarm will not be triggered. An event of partial obstruction of the camera's view can in this example result in a quality score also close to 0.8. If both of these events occur at the same time, the quality score obtained in this example could fall below 0.7, which could represent a risk for the operation and personnel. In this example, then, an alarm could be triggered.

In an alternative embodiment, the monitoring system may be further configured to trigger an alarm if a quality score remains below a threshold similarity index for a time greater than a corresponding threshold time. Accordingly, an event that would typically be of high frequency, but for some reason has become a low frequency event, can be identified. Following the same previous example, the helicopter's stay on the helideck makes the similarity index equal to 0.8. In an instance where the helicopter presents a defect or for another reason remains on the helideck for too long, the quality score would remain equal to 0.8 for a time greater than a corresponding time frame, for example, 60 minutes, which is the peak time of this operation in this example. According to this embodiment, the system would detect that the quality score remained equal to 0.8 for more than 60 minutes and an alarm could be triggered.

Optionally, various quality scores or ranges thereof can have designated time limits. For example, a quality score of 0.8 could have a time limit of 60 minutes, and/or a quality score between 0.8 and 0.7 could have a time limit of 50 minutes, and/or an index quality score between 0.7 and 0.6 could have a time limit of 30 minutes, and/or a quality score between 0.6 and 0.5 could have a time limit of 10 minutes, and/or a quality score between 0.6 and 0.5 could have a time limit of 10 minutes, and/or a quality score between less than 0.5 could have a time limit of 1 minute. Evidently, the time period chosen for taking the image frames must be in accordance with the time limits for each quality score or score intervals.

Optionally, there may be multiple sets of quality score thresholds and time limits that are applied at different parts of the monitoring period. For example, the late morning and midafternoon periods, where there is more incident sunlight, may have lower quality scores and time limits than the early morning and late afternoon periods, where there is less incident sunlight. The method described herein allows one to adjust any number of limit sets and limit ranges one desires.

Optionally, the method of the present invention can cause the system to gather at the end of the monitoring period one or more, preferably all, of the frames obtained during the monitoring period and produce a report containing data on quality scores and alarms triggered during said monitoring period. To this end, the frames and data are stored in a memory during the monitoring period, at the end of which they are accessed and a specialized routine generates and sends the report. Sending can be made to the system operator or to a third party, and can be sent via Wi-Fi, Bluetooth, LAN or any other desired means. The report format can be one or more of .pdf, .xml, .pps or whatever is desired. Routines capable of generating such reports from a database are well known in the art and will not be addressed here.

Optionally, in embodiments where limit quality scores are implemented, alarms that may be triggered during the monitoring period can also be saved in the memory and included in the report. Such alarms can be triggered when a relative quality score is below a threshold quality score or when it has remained below a threshold quality score for a certain time.

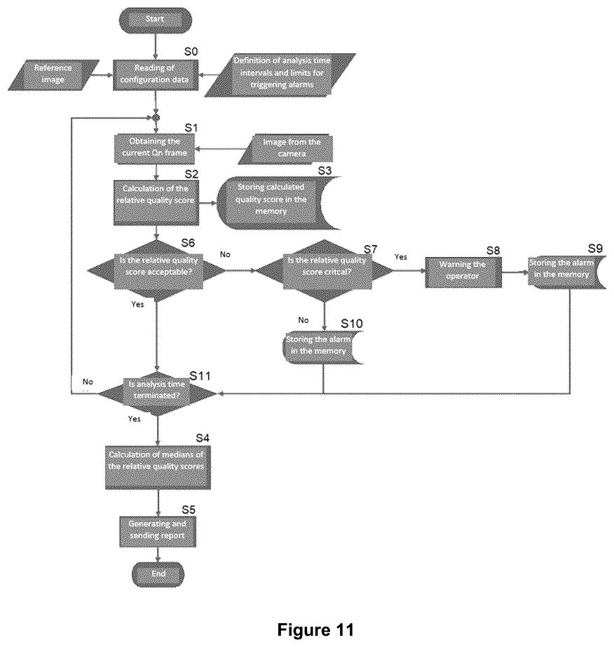

In summary, the monitoring method of the present invention includes one or more of the steps below with reference to FIG. 11:

S0—Reading the configuration data: parameters are chosen such as the reference image frame (QR, QRp, Qrv), QS limit parameters and time limit for alarm triggering, monitoring period, time interval (t) between obtaining additional Qn frames;

S1—Obtaining the current Qn frame: the current image frame is obtained through the image captured by the camera;

S2—Calculation of the relative quality score: the quality score of the current frame when compared with the reference image frame;

S3—Store calculated quality score in the memory: optionally, the relative quality score calculated in step S2 is stored in the memory;

S11—Analysis Time Completed: determination is made as to whether the monitoring period has come to an end. If not, the method waits for the time t defined in step S0 and then returns to step S1. If so, the method goes to step S4; and

S4—Calculation of medians of relative quality scores: one or more medians (QSm, QSmp, QSmv) are calculated at this stage depending on the chosen frame or reference frames, as previously disclosed.

Preferably, but optionally, a report containing one or more of the data obtained and calculated during the monitoring period is generated and sent in step S5 for further analysis.

The method of the present invention may further include the following optional steps:

S6—Acceptable relative quality score: it is determined whether the relative quality score obtained in step S2 is below a threshold quality score (for example, 0.8) and/or if it has remained below a threshold quality score for a time greater than an upper time limit (e.g., below 0.8 for more than 60 minutes) as previously disclosed in the present application. At this stage, one needs to access the memory where the relative quality scores and their timestamps are stored to make such determinations. If it is determined that the relative quality score obtained in step S2 is not below a threshold quality score, then the method proceeds to step S11. Otherwise an alarm is triggered.

S7—The relative quality score is critical: if an alarm is triggered in step S6, it can further be determined whether the relative quality score obtained in step S2 is below a threshold quality score such that the operator must be immediately warned (e.g. example, below 0.5 for more than 10 minutes). If not, the alarm triggered in step S6 is stored in the memory in step S10 and the method proceeds to step S11. If positive, an alarm is triggered.

S8—Warning the Operator: An alert such as a visual or audible warning, but not limited to these, is triggered so that an operator is notified that a serious fault has occurred and requires immediate correction. Then, the alarm triggered in step S7 is stored in the memory in step S10 and the method proceeds to step S11.

In an alternative embodiment of the present invention, a non-transitory computer readable medium is provided. The medium may be, for example, a memory, a flash memory, a hard disk, a compact disk, or any other device capable of storing computer instructions. When the readable medium of the present embodiment is read by a computer, the computer is enabled to carry out embodiments of the method of the present invention as previously described.

Although aspects of the present disclosure may be susceptible to various modifications and alternate forms, specific embodiments have been shown by way of example in the drawings and have been described in detail herein. It should be understood that the invention is not intended to be limited to the particular forms disclosed herein. Instead, the invention must cover all modifications, equivalents and alternatives that fall within the scope of the invention as defined by the following appended claims.

1. An image monitoring method comprising the steps of:
obtaining an image frame;
comparing the obtained image frame with at least one reference image frame to obtain at least one relative quality score;
storing the relative quality score obtained;
after a predetermined time has passed, repeating the obtaining, comparing, and monitoring steps until a monitoring period comes to an end; and
calculating a median quality score of the at least one relative quality score obtained during the monitoring period.

2. The method of claim 1, wherein a comparison between the obtained image frame and the at least one reference image frame is made by at least one of a MS-SSIM algorithm or a ratio of Laplacian variances.

3. The method of claim 1, wherein the storing step further comprises:
determining whether the obtained relative quality score is below a predetermined threshold;
if the obtained relative quality score is below the predetermined threshold, calculating a time in which the obtained relative quality score remains below the predetermined threshold; and
triggering an alarm if the relative quality score obtained remains below the predetermined threshold for a period of time greater than a time limit.

4. The method of claim 3, wherein a plurality of time limits are each assigned to a predetermined range of quality scores.

5. The method of claim 1, wherein the predetermined time is 1 minute, 10 minutes, 15 minutes, 30 minutes, or 60 minutes.

6. A computer-readable non-transitory storage medium comprising instructions stored thereon, wherein the instructions, when read by a computer, cause the computer to run the steps of the method as defined in claim 1.
